(19) United States
(12) Patent Application Publication
(10) Pub. No.: US 2016/0354977 A1
(43) Pub. Date: Dec. 8, 2016

(54) FUSED FILAMENT FABRICATION EXTRUDER

(71) Applicant: Mark Christopher Gordon, Vienna, VA (US)

(72) Inventor: Mark Christopher Gordon, Vienna, VA (US)

(21) Appl. No.: 14/732,761

(22) Filed: Jun. 7, 2015

(51) Int. Cl. B29C 67/00

(52) U.S. Cl. CPC B29C 67/0055; B29C 67/0085; B33Y 30/00

(57) ABSTRACT

3D Fused Filament Fabrication (FFF) is improved by heating the deposition nozzle with one or more non-contact heat sources. 3D FFF is also improved by cooling the deposition nozzle with one or more active cooling elements. Temperature control of the deposition nozzle is improved due to the reduction in mass of the nozzle by eliminating conductive heat elements and their associated devices, such as thermal transfer blocks. Responsiveness of the nozzle is improved by using lasers as non-contact heating sources, allow for rapid changes in temperature when necessary.

### BACKGROUND

1. Field

The present invention relates to additive 3D fabrication, and, more particularly, to a fused filament fabrication extruder.

2. Description of the Related Art

The extrusion point of a Fused Filament Fabrication (FFF) 3D printer is commonly referred to as a hot end. In these printers, the hot end heats the material being extruded to create a 3D object. The hot end is typically connected to a 3 axis carriage which is typically a Cartesian or polar coordinate arrangement, and allow movement of a FFF deposition head freely in 3D space. Typically, the source of heat used to melt the extruded material is a conductive heater in contact with a heater block connected with the nozzle or liquefier tube feeding the nozzle. Heat is then spread primarily via conduction from the heat source to the nozzle. This process results in high thermal capacitance, due to the heat conducting through the entire heater block and nozzle mass. It also results in high thermal radiation waste heat, due to the relatively large surface area of the assembly. This means a relatively large amount of heat is lost to the ambient environment or significant mass and size from thermal insulation must be added to retain this heat.

### BRIEF DESCRIPTION OF THE DRAWINGS/FIGURES

The following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies. However, embodiments are not limited to the specific implementations disclosed herein.

FIG. 1 shows a block diagram of an exemplary system in which embodiments of a fused filament fabrication extruder are shown.

FIG. 2 shows a block diagram of an exemplary system in which embodiments of a fused filament fabrication extruder with multiple material feedstock inputs is shown.

Exemplary embodiments will now be described with reference to the accompanying figures.

### DETAILED DESCRIPTION

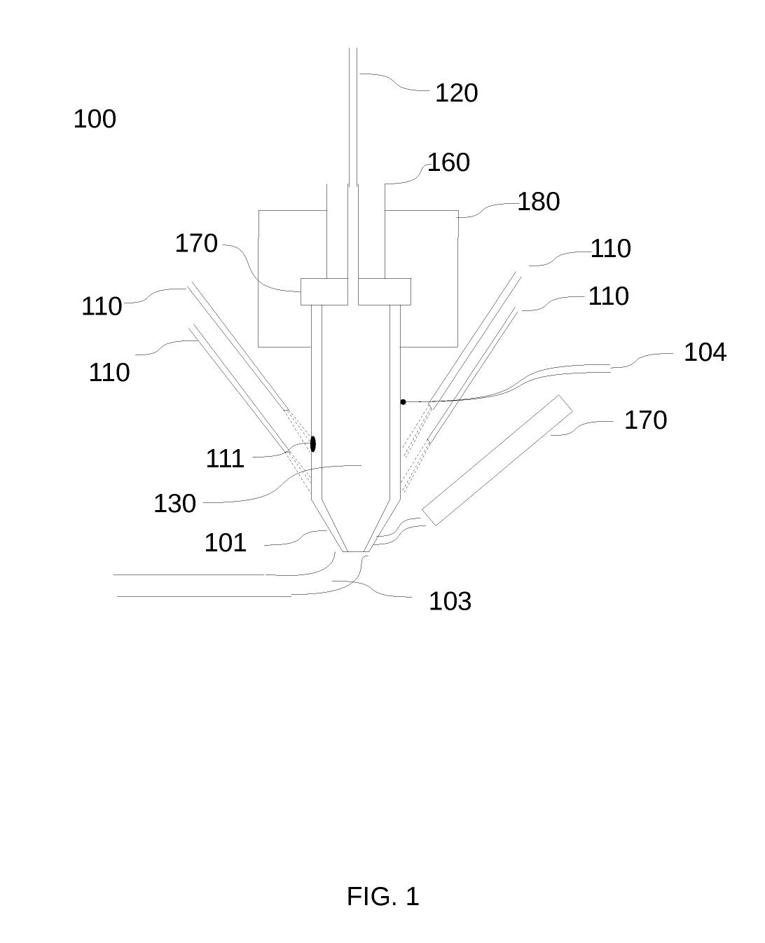

FIG. 1 illustrates a FFF hot end 100 of a FFF 3D printer according to embodiments of the present invention. In this embodiment, one or more non-contact heat sources 110 heat the FFF deposition nozzle 101. In an example embodiment non-contact heat sources 110 may be a laser. In this example embodiment, heat is generated directly by the laser excitation of the nozzle 101. The use of a laser heat source in this manner eliminates the need for heat transfer elements attached to the nozzle 101, such as a metal block or resistive heater.

The nozzle 101 extrudes a narrow strand of melted material 103. The material feedstock 120 is shown as a cylinder however it can be of any shape or size. In an embodiment the shape could be a ribbon or other thin profile to allow for faster heating of the material feedstock 120. Pressure is required to force the melted material through the nozzle 101.

Melt zone 130 is where the material feedstock 120 is liquefied by the heat of the nozzle 101. There is a temperature gradient along the nozzle 101. Sections of nozzle 101 farther from where non-contact heat sources 110 apply energy will be cooler. Sections of nozzle 101 far enough from the non-contact heat sources 110 energy may not be hot enough to melt the material feedstock 120. Therefore the size of the melt zone 130 may be smaller than the size of the nozzle if high enough temperature gradients are present. It may be desirable to minimize the size of the melt zone 130 behind the nozzle 101 when it is necessary to frequently stop and start the flow of the material.

Larger flows of melted material 103 may be desirable. A longer melt zone 130 increases potential melted material 103 flow volume. In this scenario any portion of the nozzle 101 that is not hot enough to melt the material feedstock 120 can be heated with addition non-contact heat sources 120. These additional non-contact heat sources 110 can operate independently to extend the length of the melt zone, allowing for faster printing. If the non-contact heat sources 110 are lasers the high energy density allows quick response to changing print conditions by heating nozzle 101 to extend melt zone 130.

Minimizing the size of the nozzle 101 and associated heating elements is also desirable. In an embodiment, multiple nozzles 101 are incorporated into a 3D FFF printer. Smaller nozzles 101 allow for higher density nozzle placement. Higher density nozzle placement helps improve speed and accuracy of prints, particularly in systems with multiple nozzles 101.

Nozzle 101 is typically made of metal, for example brass. Nozzle 101 could be made of any material, including metals, ceramics or other materials with appropriate strength, thermal conductivity any other desirable properties. The nozzle orifice can be of any size or shape, but is typically between 200 microns and 1500 microns. The nozzle 101 can be of any length or shape appropriate for extruding liquefied material feedstock 120. The nozzle 101 may be made up of multiple parts.

A surface treatment may be required for the nozzle 101 to absorb the energy from the non-contact heat source 110. In an example embodiment, the nozzle 101 has a black chrome surface treatment. In other example embodiments of nozzle 101 other surface treatments are possible, such as black paints with high temperature capabilities such as are commonly available. Any surface that absorbs the type or frequency of energy generated by the non-contact heat source 110 could be used. The surface treatment size may be limited to the area where the heat source 110 applies energy. Some surface treatments, such as black paints, may have high IR emissivity. If the surface treatment has high IR emissivity reducing the surface treatment size will reduce the radiated heat loss via the nozzle 101.

In an example embodiment, a small cavity 111 is made where the heat source 110 energy is incident on the nozzle 101. The cavity has the effect of trapping reflected energy and to re-radiate the energy back into the nozzle. The cavity 111 would allow for higher retention of applied power, particularly if the nozzle 101 does not have 100% absorption of the heat energy. For example, if the energy absorption of the cavity 111 from non-contact heat sources 110 is 80% any reflections that are absorbed in the cavity will have a minimum of 96% absorption, increasing the energy absorbed by the nozzle 101.

When a laser is used as the heat source 110 the laser spot size is maximized so the light energy is spread across the maximum surface area of the nozzle 101. This minimizes hot spots on the nozzle 101. In an example embodiment, a plurality of non-contact heat sources 110 are used to distribute the heat more evenly across the surface of the nozzle 101. In an embodiment with a laser as one or more of the non-contact heat sources 110 a beam splitter may also be used to generate multiple energy distribution locations. The laser is a fiber coupled laser. The fiber guides the light to the nozzle, allowing the laser to be outside the deposition area or build chamber, which frequently has an ambient temperature too hot for lasers. The fiber may have a high temperature sheathing if necessary to withstand the high ambient temperatures in the area of the nozzle, which may be over 300 degrees Celsius. If the emission end of the fiber coupled laser can is close enough to the nozzle 101 no collimating optics are needed to focus the fiber coupled laser. This significantly reduces the complexity and cost of using a laser as the non-contact heat source 110.

If significant active cooling is present across the tip of the nozzle 101, it can be difficult to maintain the temperature of nozzle 101. The tip of nozzle 101 may become significantly cooler than the area closer to the heat source 110. In an embodiment, the energy from heat source 110 can be applied very close to the tip of the nozzle 101 so the temperature of the tip can be maintained more easily at a desired target temperature.

Maintenance of the temperature within a tight band is important in the melt chamber 130. This is typically accomplished through a feedback loop with a temperature sensor. In an example embodiment, the non-contact heat source 110 has the ability to have its power modulated based on feedback from a temperature sensor 104.

Thermally conductive mass increases the thermal capacitance of a system. The larger the mass of the heat block and any other thermally conductive components connected to nozzle 101 the higher the thermal capacitance in the feedback loop. Thermal capacitance in the feedback loop slows temperature response time, reducing the ability to control the system in response to changing conditions. With the system described herein, the thermal capacitance can be minimized to only what is necessary to provide physical support for extrusion of feedstock material 120, allowing optimal control of thermal conditions. In an embodiment, any materials in contact with nozzle 101 and having at least 25% of the mass of nozzle 101 have a thermal conductivity of 2 W/m*° K or less.

During high speed printing the amount of energy needed at nozzle 101 to melt feedstock material 120 can change rapidly. Maintaining the temperature accurately can minimize certain undesirable outcomes, such as molten material oozing from the tip of nozzle 101 when the flow of melted material 103 should be stopped or overheating of melt chamber 130. FIG. 1 illustrates active cooler 170 cooling the nozzle 101. In an embodiment, active cooler 170 is activated and non-contact heat sources 110 are de-activated, rapidly reducing the temperature of nozzle 101.

Nozzle mount 180 attaches the heated nozzle 101 to the FFF printer. The temperature of nozzle 101 can be in excess of 325° C. In an embodiment, nozzle mount 180 is made of material that can withstand the operating temperatures of greater than 325° C. and has a thermal conductance of less than 2 W/m*° K. For example, the type of material that may be used is Macor®, which can withstand temperatures of 800° C., has thermal conductivity of 1.46 W/m*° K and is easily machined. In a further example, the type of material used is Mycalex®, which has a lower thermal conductivity than Macor®. In an example embodiment the nozzle mount 180 is tapped to allow a threaded nozzle 101 to be fitted. Nozzle 101 could also be mounted in nozzle mount 180 with high temperature adhesive instead of threading to better contain the melted material feedstock 120. A combination of adhesive or other sealing agents and threading or other mounting methods could also be used. The nozzle 101 may have an additional insulating layer 170 between it and the material feedstock inlet 160. In an embodiment, the insulating layer is created during the machining process for nozzle mount 180 by leaving an insulating layer 170 in between the material feedstock inlet 160 and the nozzle 101. The hole in nozzle mount 180 may be a through hole and an insulating layer 170 of any material with appropriate thermally insulating and heat resistant properties is placed in between feedstock inlet 160 and nozzle 101. One or more holes sufficient to allow material feedstock 120 to be fed into the nozzle 101 through the insulating layer 170 exist.

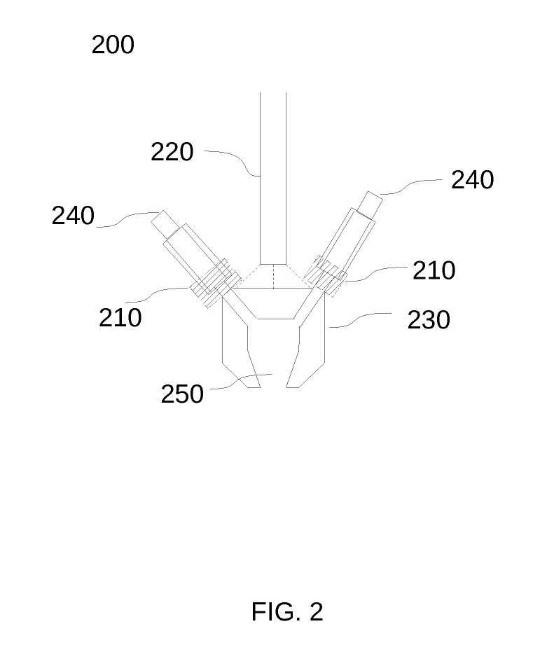

FIG. 2 illustrates a color blending nozzle 200. The color blending nozzle 200 has characteristics similar to the nozzle 100 in FIG. 1 but is optimized for multiple color input material feedstocks 240. Two or more input colors of material feedstocks 240 are blended in the melt chamber 250 to generate a large number of output colors. For example, with CMYK color inputs, it is possible to generate a large number of color outputs by blending the input colors in correct ratios. One of the challenges with this technique is the size of the melt chamber 250. Although the ratio of material feedstocks 240 can be varied continuously, as the melted material moves down the melt chamber 240 it will tend to mix along the length of the melt chamber 240. This causes the color fidelity to be reduced when changing colors. The nozzle 230 shown in FIG. 2 minimizes the melt chamber 240 using an extremely small melt chamber 240 with one or more non-contact heat sources 220. With a very small melt chamber 240 and small diameter material feedstock 240 the output color can be tightly controlled and varied quickly. In addition, with a very small melt chamber 240 retraction needed during printing is minimal, thereby further reducing color mixing in the melt chamber 240. In an embodiment, the melt chamber 240 is less than 5 mm³ in volume. In an embodiment material feedstocks 240 are smaller than 1.75 mm in diameter. Nozzle mounts 210 are similar in construction and materials to nozzle mounts 180. Nozzle mounts 210 are smaller in size than nozzle mount 180. The thermally insulating nature of the nozzle mounts 210 further reduce the amount of melted material feedstock 240 as the temperature outside the melt chamber is decrease quickly.

The 3D FFF printer will also comprise standard components not pictured, such as a controller, three dimensional carriage, a bed to deposit the object upon and other electrical and mechanical systems as needed to actuate the 3D print nozzle.

While the technology has been described in conjunction with various embodiments, it will be understood that the embodiments are not intended to limit the present technology. The scope of the subject matter is not limited to the disclosed embodiment(s). On the contrary, the present technology is intended to cover alternatives, modifications, and equivalents, which may be included within the spirit and scope the various embodiments as defined herein, including by the appended claims. In addition, in the following detailed description, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the embodiments presented.

References in the specification to “embodiment,” “example” or the like indicate that the subject matter described may include a particular feature, structure, characteristic, or step. However, other embodiments do not necessarily include the particular feature, structure, characteristic or step. Moreover, “embodiment,” “example” or the like do not necessarily refer to the same embodiment. Further, when a particular feature, structure, characteristic or step is described in connection with an embodiment, it is within the knowledge of one skilled in the art to effect it in embodiments.

Alternative embodiments may use other techniques and/or steps within the spirit and scope of the disclosed technology. The exemplary appended claims encompass embodiments and features described herein, modifications and variations thereto as well as additional embodiments and features that fall within the spirit and scope of the disclosed technologies. Thus, the breadth and scope of the disclosed technologies is not limited by foregoing exemplary embodiments.

What is claimed is:

1. A device for printing a three dimensional fabrication of an object, comprising:
a nozzle configured to deposit molten material for creating a 3D object; and
a non-contact energy source configured to heat the nozzle.

2. The device of claim 1, wherein the non-contact energy source is a fiber coupled laser.

3. The device of claim 1, wherein at least a portion of the nozzle absorbs greater than 25% of incident light energy.

4. The device of claim 1, further comprising an active cooler coupled to the nozzle configured to cool the nozzle to rapidly reduce the nozzle temperature.

5. The device of claim 1, wherein material in contact with the nozzle with a mass of least 25% of the nozzle has a thermal conductivity of less than 2 W/m*K.

6. The device of claim 2, wherein the fiber coupled laser is configured without collimating optical devices.

7. The device of claim 2, wherein at least a portion of the nozzle's surface absorbs greater than 25% of incident light energy.

8. The device of claim 2, wherein the fiber includes sheathing that can withstand temperatures above 180 degrees Celsius.

9. The device of claim 2, further comprising an active cooler coupled to the nozzle configured to cool the nozzle to rapidly reduce the nozzle temperature.

10. The device of claim 2, wherein the laser of the fiber coupled laser is outside of the build chamber of the 3D printer.

11. A system for printing a three dimensional fabrication of an object, comprising:
a nozzle configured to deposit molten material for creating a 3D object; and
a non-contact energy source configured to heat the nozzle.

12. The system of claim 11, wherein the non-contact energy source is a fiber coupled laser.

13. The system of claim 11, wherein at least a portion of the nozzle absorbs greater than 25% of incident light energy.

14. The system of claim 11, further comprising an active cooler coupled to the nozzle configured to cool the nozzle to rapidly reduce the nozzle temperature.

15. The system of claim 11, wherein material in contact with the nozzle with a mass of least 25% of the nozzle has a thermal conductivity of less than 2 W/m*K.

16. The system of claim 12, wherein the fiber coupled laser is configured without collimating optical devices.

17. The system of claim 12, wherein at least a portion of the nozzle's surface absorbs greater than 25% of incident light energy.

18. The system of claim 12, wherein the fiber includes sheathing that can withstand temperatures above 180 degrees Celsius.

19. The system of claim 12, further comprising an active cooler coupled to the nozzle configured to cool the nozzle to rapidly reduce the nozzle temperature.

20. The system of claim 12, wherein the laser of the fiber coupled laser is outside of the build chamber of the 3D printer.
